(19) United States
(12) Patent Application Publication
(10) Pub. No.: US 2026/0042196 A1
(43) Pub. Date: Feb. 12, 2026

(54) Hammer Safety Devices

(71) Applicant: HANDY FAMM IP HOLDINGS, LLC, Boca Raton, FL (US)

(72) Inventor: Joshua White, Boca Raton, FL (US)

(21) Appl. No.: 19/281,096

(22) Filed: Jul. 25, 2025

Related U.S. Application Data
(60) Provisional application No. 63/682,106, filed on Aug. 12, 2024.

(51) Int. Cl. B25D 1/00

(52) U.S. Cl. CPC B25D 1/00

(57) ABSTRACT

The disclosed technology includes a hammer. In one example, the hammer may include a head and a handle coupled to the head. The head may include a striking surface. A lip may surround an outer periphery of the striking surface. The lip may be made of a material that is softer and more elastic than the striking surface. The lip may extend out beyond the striking surface to contact a surface without the striking surface contacting the surface.

### CROSS REFERENCE TO RELATED APPLICATIONS

The present application claims the benefit of priority to U.S. Provisional Patent Application No. 63/682,106, entitled “Hammer Safety Devices,” filed Aug. 12, 2024, the entirety of which is hereby incorporated by reference herein for all purposes.

### TECHNICAL FIELD

The technology described herein relates generally to safety devices for a hammer.

### BACKGROUND

Hammers are typically made of a strong and hard metal, such as steel, to effectively insert a fastener, often a metal nail, into a surface. The strong and hard material prevents the hammer from bending or getting damaged when it strikes against the fastener. These hand tools can be dangerous, particularly for children or those with reduced dexterity or coordination, as users can accidentally strike their fingers with the hard metal striking surface of the hammer. There is a need for a safety feature on hammers that prevents injury.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes hammer safety devices. Embodiments of the present disclosure may include a hammer with a hammer safety device. The hammer may include a head including a striking surface, a handle coupled to the head, and a lip surrounding an outer periphery of the striking surface, wherein the lip is made of a material that is softer and more elastic than the striking surface. The lip may extend out beyond the striking surface to contact a surface without the striking surface contacting the surface.

Other examples or embodiments of the present disclosure may include a hammer, including a head, a handle coupled to the head, and a hammer safety device coupled to the head. The head may include a neck and a face coupled to the neck. The face may have a diameter that is greater than a diameter or width of the neck and the face may define a striking surface. The hammer safety device may include a safety device body. At least a portion of the neck may be surrounded by the safety device body. A lip may be defined at one end of the safety device body. The lip may at least partially surround a circumference of the striking surface and may extend outward from the striking surface. The lip may be made of a material that is more elastic than a material of the striking surface.

Further examples or embodiments of the present disclosure may include a hammer safety device including a safety device body and a lip defined at one end of the safety device body. The safety device body and the lip may define a safety device cavity that is sized and shaped to correspond to a size and shape of a neck or housing of a hammer. The lip may form a ring around a circumference of the safety device body. The lip may have a diameter that is sized to correspond to a size of a diameter of a striking surface of the hammer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a front isometric view of a first embodiment of a hammer including a hammer safety device.

FIG. 2 is a front elevation view of the hammer of FIG. 1.

FIG. 3 is a right side view of the hammer of FIG. 1.

FIG. 4 is a front isometric view of a second embodiment of a hammer with a hammer safety device.

FIG. 5 is a right side view of the hammer of FIG. 4.

FIG. 6 is an exploded view of the hammer of FIG. 4.

FIG. 7 is a top isometric view of the head of the hammer of FIG. 4.

FIG. 8 is a top plan view of the head of FIG. 7.

FIG. 9 is a front isometric view of the hammer safety device of the hammer of FIG. 4.

FIG. 10 is a front elevation view of the hammer safety device of FIG. 9.

FIG. 11 is a rear isometric view of the hammer safety device of FIG. 9.

FIG. 12 is a cross-section view of the head and hammer safety device of the hammer of FIG. 4 taken along line 12-12.

FIG. 13 is a right side view of the hammer of FIG. 4 striking against a nail.

FIG. 14 is an exploded view of an alternate embodiment of the hammer components of the hammer of FIG. 4.

FIG. 15 is a right side exploded view of the head of the hammer components of FIG. 14.

FIG. 16 is a left side rear isometric view of the head of FIG. 15.

FIG. 17 is a left side isometric view of the housing of the hammer components of FIG. 14.

FIG. 18 is a right side view of the left side housing component of the housing of FIG. 17.

FIG. 19 is a front isometric view of the hammer safety device of the hammer components of FIG. 14.

FIG. 20 is a rear isometric view of the hammer safety device of FIG. 19.

FIG. 21 is a cross-section view of the head of the hammer components of FIG. 14 taken along the same line 12-12 of FIG. 4 as FIG. 12.

### DETAILED DESCRIPTION

This disclosure is related to hammer safety devices. A conventional hammer includes a head coupled to a handle. The head may include a neck coupled to a face. The face may define a striking surface. In operation, the striking surface may hit a fastener, such as a nail, to drive the fastener into a surface. Disclosed hammer safety devices may include a lip that couples to or surrounds a striking surface of a hammer head. Disclosed hammer safety devices may include a guard, shield, sleeve, or cover that couples to the hammer head. In some embodiments, the guard, shield, sleeve, or cover may enclose at least a portion of the neck and face of a hammer. Disclosed hammer safety devices may extend beyond the striking surface of the hammer head to contact a surface or object before or instead of the striking surface of the hammer head contacting the same surface or object. Disclosed hammer safety devices may be made of a material that is durable and resilient and that is softer, more malleable, and less rigid than the material of the hammer head to soften the impact of the hammer against an unintentional target, such as a user's finger(s). In this manner, disclosed hammer safety devices may prevent injury caused by the hard striking surface, thereby improving the safety of a hammer.

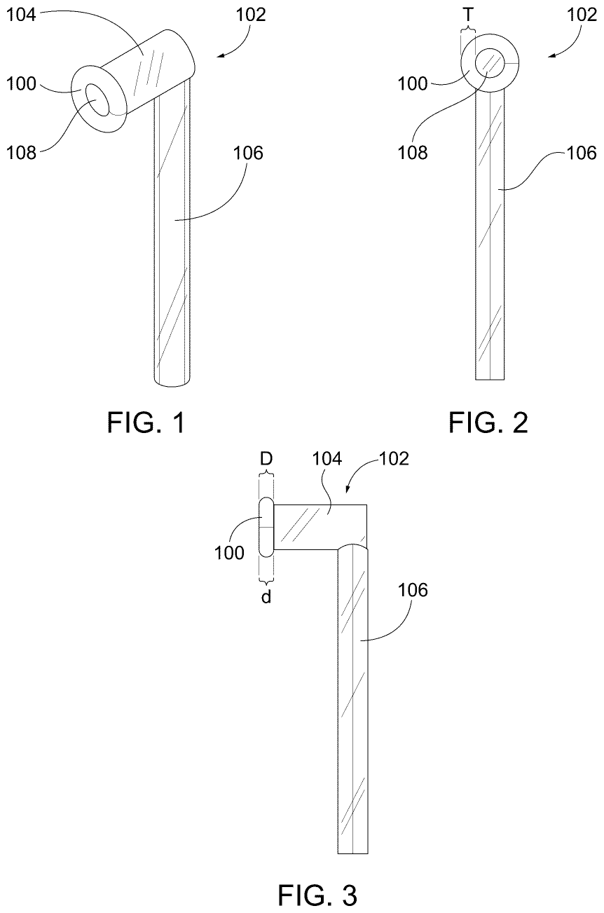

Turning to the figures, hammer safety device embodiments of the present disclosure will now be discussed in more detail. FIGS. 1-3 show a first embodiment of a hammer safety device 100 coupled to a hammer 102. FIG. 1 is a front isometric view of the hammer 102 with the hammer safety device 100. FIG. 2 is a front elevation view of the hammer 102 of FIG. 1. FIG. 3 is a right side view of the hammer 102 of FIG. 1. As shown, the hammer 102 may include a head 104 coupled to a handle 106. The head 104 may include a striking surface 108. The striking surface 108 may be flat or have a convex curvature. The hammer safety device 100 may be coupled to the head 104. In the depicted embodiment, the hammer safety device 100 forms a lip or rim that surrounds an outer edge or outer periphery of the striking surface 108. The hammer safety device 100 may extend around a portion of the circumference of the striking surface 108. As shown, the hammer safety device 100 extends around the circumference of the striking surface 108. The hammer safety device 100 may have a thickness T, a depth D, and may extend in a distance d from the striking surface 108. The thickness T may be between about 0.50 mm and about 5 mm. For example, the thickness T may be about 1 mm (e.g., 0.95-1.05 mm) to about 3.95 mm (e.g., 3.90 mm-4.0 mm). For example, the thickness T may be between 1.04 mm and 3.91 mm. The depth D may be between about 2 mm and about 6.5 mm. For example, the depth D may be about 3.3 mm (e.g., 3.15 mm-3.45 mm) to about 5.5 mm (e.g., 5.25 mm-5.75 mm). For example, the depth D may be between 3.38 mm to 5.67 mm. The thickness T and/or depth D may vary around the circumference of the striking surface 108 or the thickness T and/or depth D may have a constant measurement around the circumference. While certain measurements are described, variations from such measurements are contemplated based on manufacturing methods and the proportions of the other components of the hammer 102 and/or hammer safety device 100. The distance d that the hammer safety device 100 extends from the striking surface 108 may be the same or less than the depth D. For example, the hammer safety device 100 may extend around a portion of the head 104 such that the distance d is less than the depth D. The hammer safety device 100 may be fixedly or removably coupled to the head 104. For example, the hammer safety device 100 may be made of a flexible material, allowing the hammer safety device 100 to stretch around the head 104 and conform to a shape of the head 104.

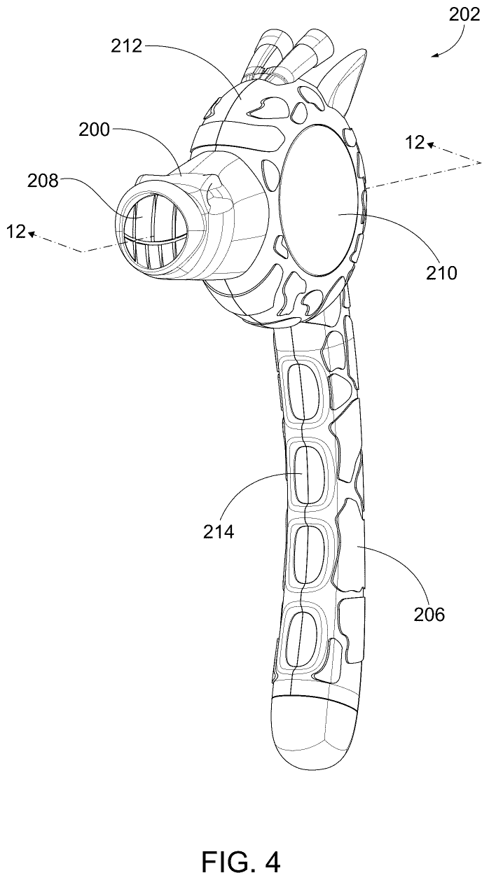

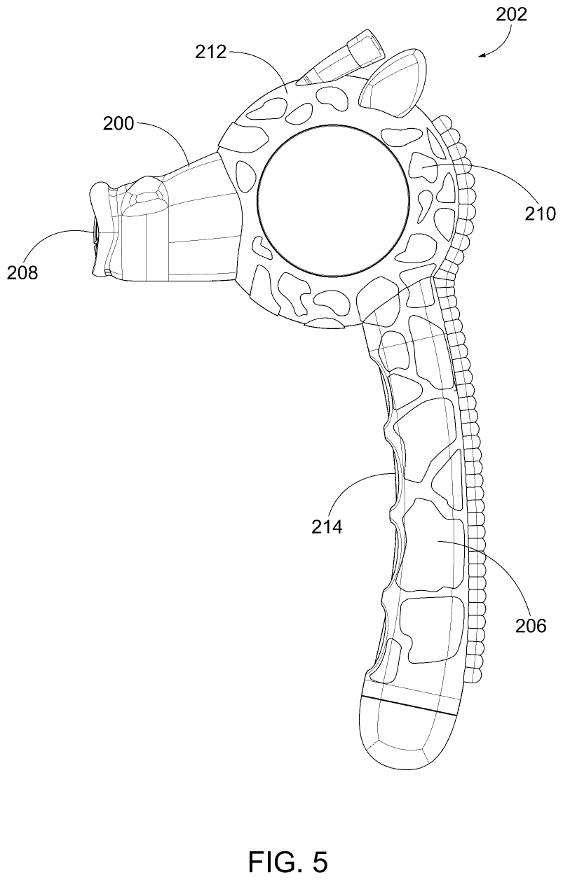

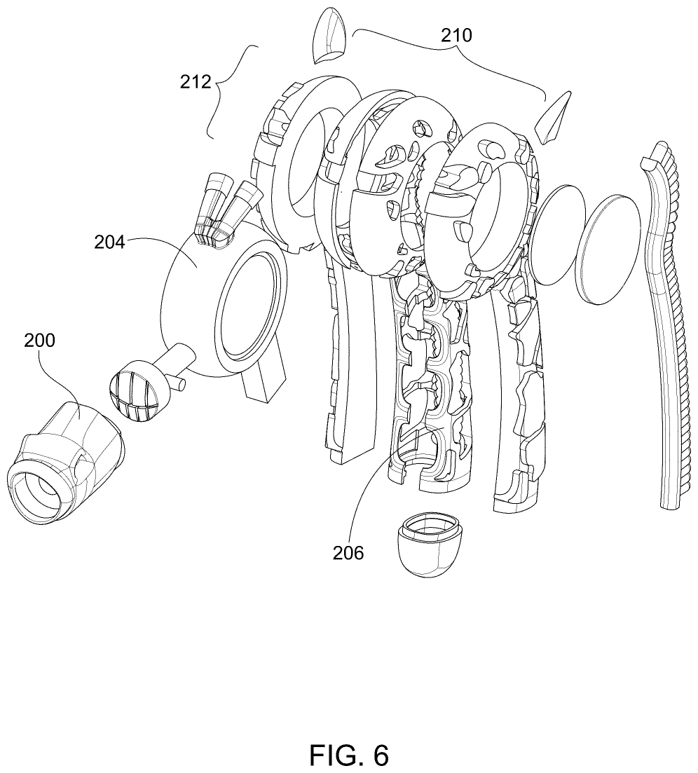

FIGS. 4-13 show a second embodiment of a hammer safety device 200 coupled to a hammer 202. FIG. 4 is a front isometric view of the hammer 202. FIG. 5 is a right side view of the hammer 202 of FIG. 4. FIG. 6 is an exploded view of the hammer 202 of FIG. 4. As shown, the hammer 202 may include a head 204 coupled to a handle 206. The head 204 may include a striking surface 208. The striking surface 208 may be flat or may have a convex curvature. With a convex curvature, the surface area of the striking surface 208 that contacts a fastener or surface may be minimized, thereby mitigating the potential for the striking surface 208 to accidentally contact an unintentional target, such as a user's finger(s). The hammer safety device 200 may be coupled to the head 204. In the depicted embodiment, the hammer safety device 200 forms a cover, sleeve, or guard around a portion of the head 204.

The hammer 202 may include a hammer housing 210. The hammer housing 210 may form the handle 206 and may form a head housing 212. The head housing 212 may surround the head 204. The hammer safety device 200 may couple to the head housing 212. The hammer housing 210 may be made of a softer material than the head 204 to improve overall safety of the hammer 202. The handle 206 may include one or more finger grips 214 to facilitate a user holding the hammer 202. It is contemplated that the hammer housing 210 may be omitted.

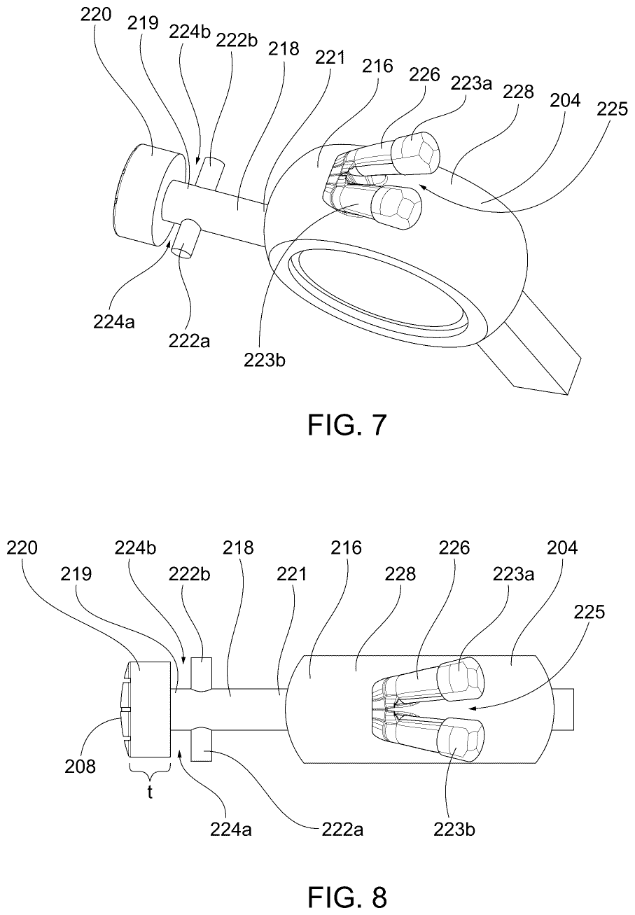

FIG. 7 is a top isometric view of the head 204 of the hammer 202 of FIG. 4. FIG. 8 is a top plan view of the head 204 of FIG. 7. As shown, the head 204 may include a head body or cheek 216, a neck 218, and a face 220. The neck 218 may couple to the head body 216 and the face 220 and may separate the face 220 from the head body 216. The face 220 may have a thickness t and may define the striking surface 208. The neck 218 may have an elongated body with a neck first end 219 and a neck second end 221. As shown, the neck 218 has a cylindrical elongated body; however, other shapes are contemplated. The face 220 may be coupled to the neck first end 219 and the head body 216 may be coupled to the neck second end 221. The neck 218 may have a consistent thickness from the first neck end 219 to the second neck end 221 or thickness may vary. The neck 218 may be straight or curved. In the present embodiment, the neck 218 is straight. The neck 218 may have a diameter that is less than a diameter of the striking surface 208. The neck 218 may include one or more safety device coupling features to couple the hammer safety device 200 to the neck 218. For example, the safety device coupling features may include one or more bosses, recesses, grooves, slots, apertures, and the like. As shown, the neck 218 includes a plurality of neck bosses 222a,b. The neck bosses 222a,b may be positioned on opposing sides of the neck 218. The neck bosses 222a,b may be positioned an equal distance from the face 220, forming gaps 224a,b between the neck bosses 222a,b and the face 220, respectively.

The head 204 may include a claw 226 coupled to a top surface 228 of the head body 216. The claw 226 may include two claw extensions 223a,b that are spaced apart so as to provide a V-shaped space 225 therebetween. A nail can be received in the V-shaped space 225 and the claw extensions 223a,b engage with the nail to remove it from a surface. The claw extensions 223a,b may include rubber or a soft material at the ends of the claw extensions 223a,b to improve the safety of the claw by preventing pinching, stabbing, or other injury from the metal or sharp ends of the claw extensions 223a,b.

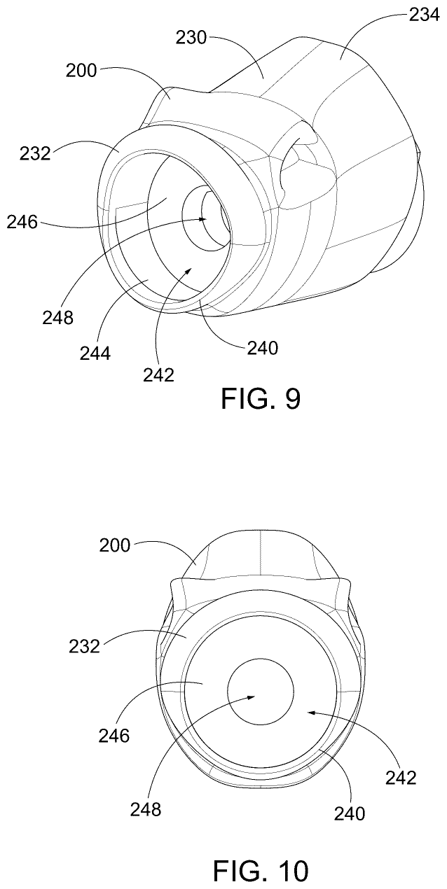

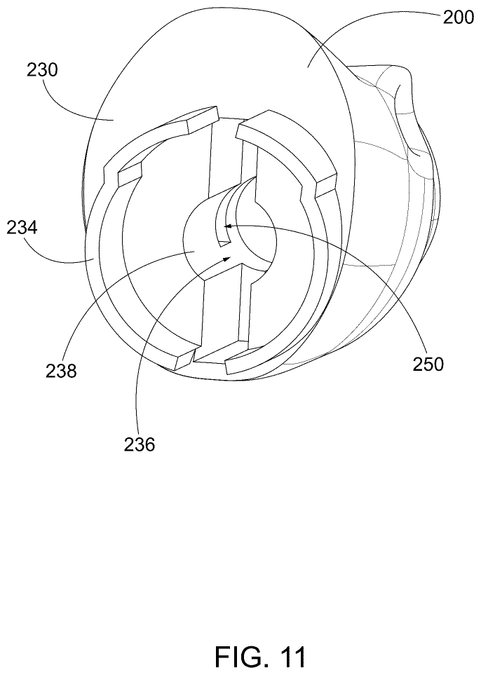

FIG. 9 is a front isometric view of the hammer safety device 200 of the hammer 202 of FIG. 4. FIG. 10 is a front elevation view of the hammer safety device 200 of FIG. 9. FIG. 11 is a rear isometric view of the hammer safety device 200 of FIG. 9. As shown, the hammer safety device 200 may have a safety device body 230 with a first end 232 and a second end 234. The safety device body 230 may have an elongated cylindrical shape. The safety device body 230 may have a consistent diameter throughout or may taper in one direction. As shown, the safety device body 230 tapers from the second end 234 to the first end 232 forming a tapered shape of the safety device body 230. The safety device body 230 may define a safety device cavity 236.

The first end 232 of the hammer safety device 200 may define a lip 240. The lip 240 may be a ridge or rim. The lip 240 may form a ring around a circumference of the safety device body 230. The lip 240 may have a larger diameter than the diameter of the safety device body 230 or than the diameter of the portion of the safety device body 230 adjacent to the lip 240. The lip 240 may have a diameter that is sized to correspond to a size of a diameter of the striking surface 208. The lip 240 may have a thickness T and a depth D that are the same as those described above with respect to the hammer safety device 100 of FIGS. 1-3. The thickness T and/or depth D may vary around the circumference of the striking surface 208 or the thickness T and/or depth D may have a constant measurement around the circumference. The lip 240 and a portion of the safety device body 230 may define a face cavity 242 therein. The face cavity 242 may be defined by a side face cavity wall 244 and a rear face cavity wall 246. A neck aperture 248 may be defined in the rear face cavity wall 246. The neck aperture 248 may provide access to the safety device cavity 236. In some embodiments, the rear face cavity wall 246 and the neck aperture 248 may be omitted and the face cavity 242 and the safety device cavity 236 may form a single safety device cavity. The lip 240 may surround at least a portion of the rear face cavity wall 246. As shown, the lip 240 surrounds the entire rear face cavity wall 246.

The second end 234 may provide access to the safety device cavity 236. The safety device cavity 236 may be defined by a safety device cavity wall 238. The safety device cavity wall 238 may include one or more neck coupling features to couple the hammer safety device 200 to the neck 218. For example, the neck coupling features may include one or more bosses, recesses, grooves, slots, apertures, and the like. As shown, the safety device cavity wall 238 defines boss apertures 250 on opposing sides of the safety device cavity wall 238 (a second boss aperture is not shown but may be a mirror image of the boss aperture 250 depicted). The safety device cavity 236 may be sized and shaped to correspond with a size and shape of the neck 218.

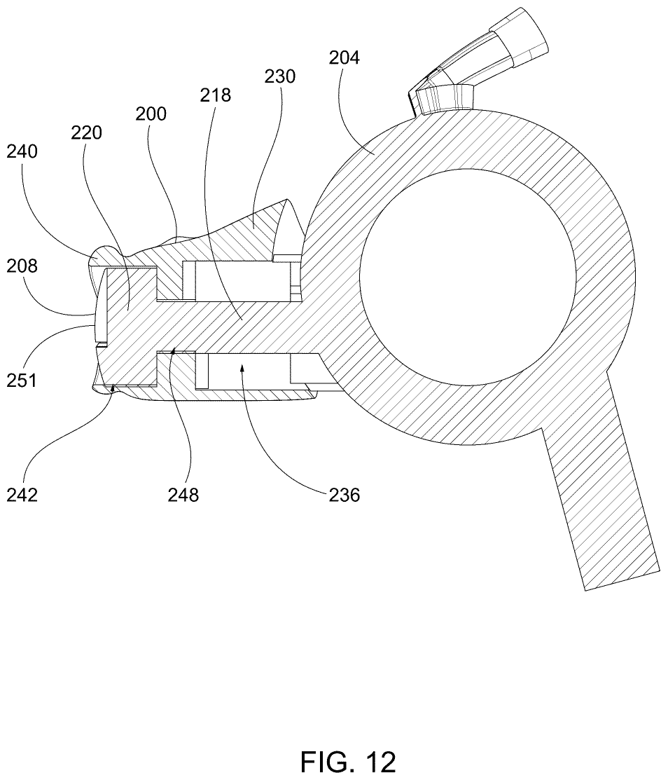

FIG. 12 is a cross-section view of the head 204 and hammer safety device 200 of the hammer 202 of FIG. 4 taken along line 12-12. The face 220 may be positioned within the face cavity 242 of the hammer safety device 200. The neck 218 may be positioned through the neck aperture 248 and may be disposed within the safety device cavity 236. The neck bosses 222a,b may be positioned within the boss apertures 250. The rear face cavity wall 246 may be positioned within gaps 224a,b. The safety device body 230 may form a sleeve, cover, or guard around the face 220 and neck 218. The hammer safety device 200 may be positioned on the head 204 such that the lip 240 surrounds or at least partially surrounds the striking surface 208 and extends in an outward direction away from the striking surface 208. In embodiments where the striking surface 208 has a convex shape, the convex shape may have a peak or height 251 that may be positioned centrally within the lip 240 that creates a periphery around the peak 251. The lip 240 may form a circle and the peak 251 may form the center or focus of the circle.

The hammer safety device 200 may be removably coupled to the head 204. The positioning of the neck bosses 222a,b within the boss apertures 250 of the hammer safety device 200 may form a snap fit, allowing the hammer safety device 200 to be snapped onto and off of the head 204. It is contemplated that the hammer safety device 200 may be made of two or more components that can be coupled together around the head 204. For example, the two components may be snap fit together. It is further contemplated that the hammer safety device 200 may be a single component. For example, the hammer safety device 200 may be made of a flexible material that stretches over the face 220 and neck 218 of the head 204. In these embodiments, the hammer safety device 200 may be provided separately from the hammer 202. It is further contemplated that the hammer safety device 200 may be fixedly coupled to the head 204.

The hammer safety device 200 may be formed by injection molding, 3D printing, and the like. The hammer 202 may be formed as a single component (e.g., with the hammer safety device 200 molded to the head 204) or as multiple components coupled together. The hammer 202 may be formed by injection molding, 3D printing, and the like.

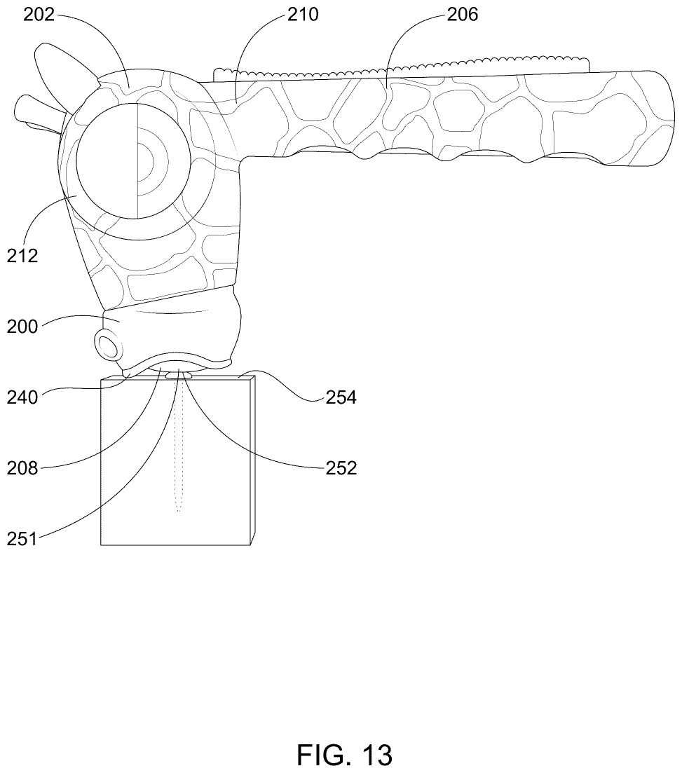

FIG. 13 is a right side view of the hammer 202 of FIG. 4 striking against a nail 252. As shown, in operation, the striking surface 208 may contact the nail 252. Specifically, the peak 251 may contact the nail 252. The lip 240 may come in close contact with or may contact a surface 254 surrounding the nail 252. If a user's fingers are positioned near the surface 254 around a periphery of the nail 252, they may be hit by the lip 240, but not by the striking surface 208, which is angled to strike a central target. The lip 240 may be made of a softer, more flexible, and more elastic material than the striking surface 208, reducing or eliminating harm to the user if the user's fingers get struck by the lip 240.

While the hammer safety device 200 is depicted with the hammer 202 and head 204 shown in FIGS. 1-8, it is contemplated that the hammer safety device 200 may be configured to couple to a conventional hammer. For example, the sizing and shape of the various components of the hammer safety device 200 (e.g., the face cavity 242, neck aperture 248, and/or safety device cavity 236) may be modified for a conventional hammer. It is contemplated in these embodiments that the boss apertures 250 may be omitted. It is contemplated that the rear face cavity wall 246 and neck aperture 248 may be omitted and that the hammer safety device 200 may define a single safety device cavity. The hammer safety device 200 may be a cover, sleeve, or guard that covers at least a portion of the face and neck of a conventional hammer.

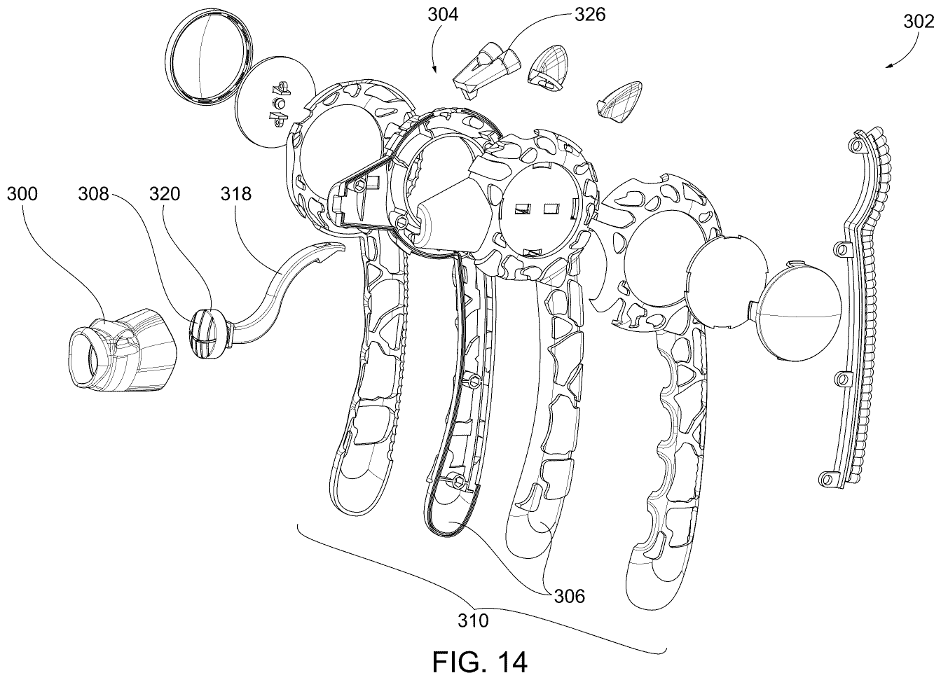

FIGS. 14-21 show an alternate embodiment of a hammer safety device 300 coupled to a hammer 302. The hammer 302 is the same as or similar to the hammer 202 depicted in FIG. 4, but with certain different component parts, as described below. FIG. 14 is an exploded view showing the alternate embodiment of the hammer components of the hammer of FIG. 4. As shown, the hammer 302 may include the same or similar components with certain parts and features modified or varied, as discussed in further detail below. To the extent features are not discussed, it is contemplated that they are the same or similar to the features described with respect to the embodiment of the hammer 202 depicted in FIGS. 4-13.

As shown, the hammer 302 may include a head 304 coupled to a handle 306. The head 304 may include a striking surface 308. The striking surface 308 may be flat or may have a convex curvature. The hammer safety device 300 may be coupled to the head 304. In the depicted embodiment, the hammer safety device 300 forms a cover, sleeve, or guard around a portion of the head 304.

The hammer 302 may include a hammer housing 310. The hammer housing 310 may form the handle 306 and may form a head housing 312. The head housing 312 may surround the head 304. The hammer safety device 300 may couple to the hammer housing 310, specifically, to the head housing 312.

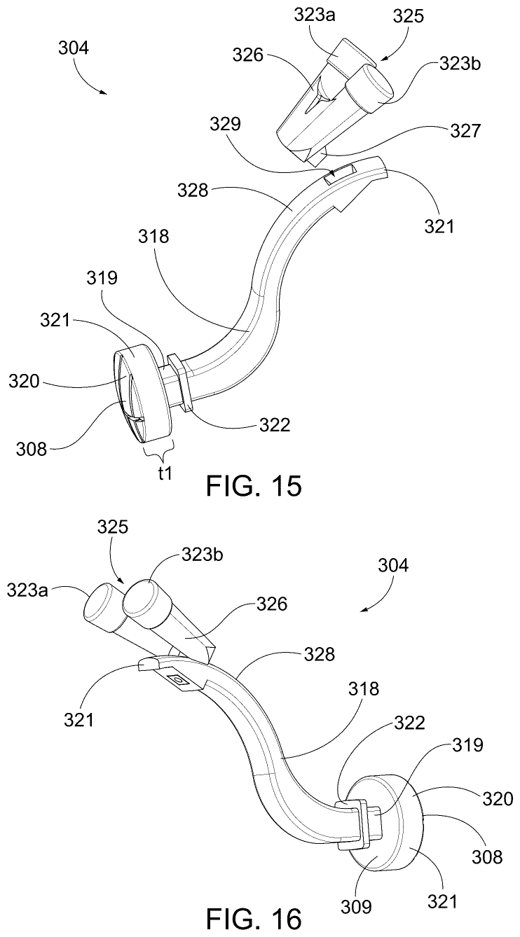

FIG. 15 is a right side exploded view of the head 304 of the hammer components of FIG. 14. FIG. 16 is a left side rear isometric view of the head of FIG. 15. As shown, the head 304 may include a neck 318 and a face 320. The face 320 may have a face body 321, a front face surface, also referred to as the striking surface 308, and a rear face surface 309. The face body 321 may be defined between the rear face surface 309 and the striking surface 308 and may have a have a thickness t1. The neck 318 may have an elongated body with a first neck end 319 and a second neck end 321. The neck 318 may include a neck top surface 328. The first neck end 319 may be coupled to the face 320. A neck aperture 329 may be defined in the neck top surface 328 at the second neck end 321. The neck 318 may have a consistent thickness from the first neck end 319 to the second neck end 321 or, as shown, the neck 318 may narrow from the first neck end 319 to the second neck end 321. The neck 318 may be straight or curved. In the depicted embodiment, the neck 318 is curved. The neck 318 may form an S-shape from the first neck end 319 to the second neck end 321; however, other shapes are contemplated. The neck 318 may have a width that is less than a diameter of the striking surface 308. The neck 318 may include one or more neck bosses. As shown, the neck 318 includes a neck boss 322 proximate to the first neck end 319. The neck boss 322 may partially surround or fully surround the neck 318. As shown, the neck boss 322 fully surrounds the neck 318. However, it is contemplated that the neck 318 may include similar neck bosses as described with respect to the head 204 of FIGS. 7 and 8. A gap or space may be defined between the neck boss 322 and the face 320.

The head 304 may include a claw 326. The claw 326 may include two claw extensions 323a,b that are spaced apart so as to provide a V-shaped space 325 therebetween. A nail can be received in the V-shaped space 325 and the claw extensions 323a,b engage with the nail to remove it from a surface. The claw extensions 323a,b may be made of metal, rubber, soft plastic, or another material. In some embodiments, the claw extensions 323a,b are made of metal and include a cover or housing that is made of rubber, soft plastic, or another soft material. The soft cover or housing may cover the entire claw extensions 323a,b or may cover the tip or ends of the claw extensions 323a,b. The soft cover or housing may be removable or integrated features of the claw extensions 323a,b. The additional soft material of the claw extensions 323a,b may improve the safety of the claw 326 by preventing pinching, stabbing, or other injury from the metal or sharp ends of the claw extensions 323a,b.

As shown, the claw 326 is a separate component from the neck 318; however, it is contemplated that the claw 326 and neck 318 may be a single component. In the depicted embodiment, the claw 326 includes a claw boss 327 on a bottom surface of the claw 326 to couple the claw 326 to the neck 318. As shown in FIG. 16, the claw 326 is coupled to the neck top surface 328 of the neck 318. The claw boss 327 may be positioned inside the neck aperture 329 to couple to the claw 326 to the neck 318.

In the depicted embodiment, the head body or cheek 216 of the head 204 of the hammer 202 described above with respect to FIGS. 4-13 is omitted. Reducing the metal components included in the head 304 of the hammer 302 embodiment of FIGS. 14-21 reduces or minimizes the weight of the head 304 and hammer 302, which may facilitate operation of the hammer 302 by a child or elderly individual.

The hammer 302 may include a hammer housing 310. The hammer housing 310 may form the handle 306 and may form a head housing 312. The head housing 312 may surround the head 304. The hammer safety device 300 may couple to the hammer housing 310, specifically, to the head housing 312.

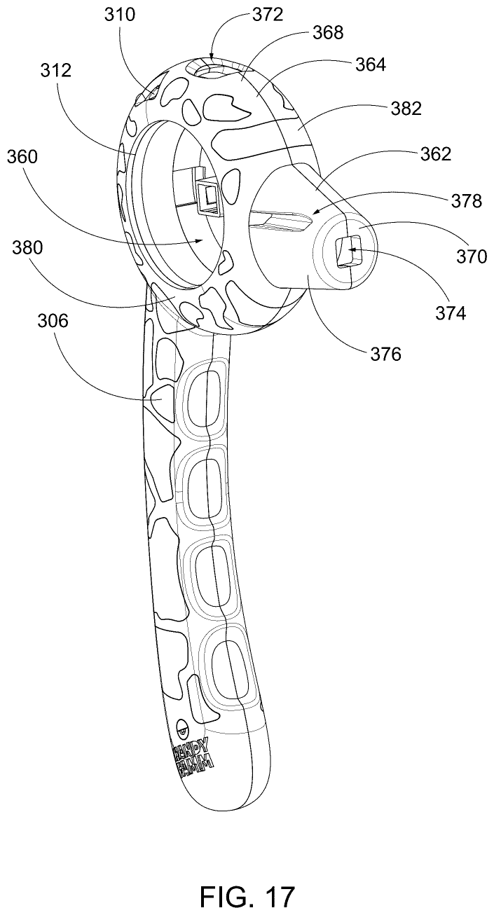

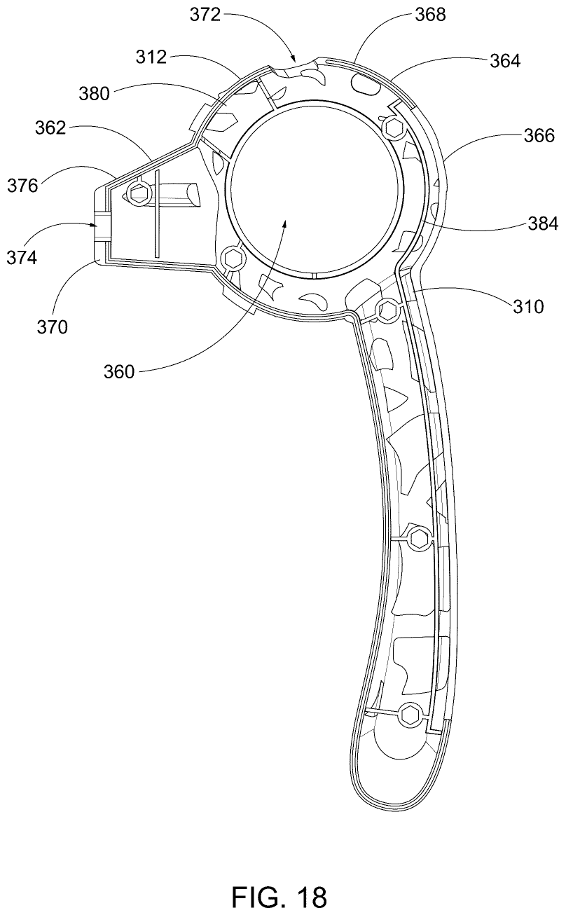

FIG. 17 is a left side isometric view of the hammer housing 310 of the hammer components of FIG. 14. FIG. 18 is a right side view of the left side housing component of the hammer housing 310 of FIG. 17. As mentioned above, the hammer housing 310 may include the head housing 312 that surrounds the head 304. The head housing 312 may define a head housing cavity 360. The head housing 312 may be shaped to enclose or surround all or a majority of the neck 318. As shown, the head housing 312 includes a neck housing component 362 that is an extension of the head housing 312. The neck housing component 362 may taper as it extends out from the head housing 312 forming a tapered shape of the neck housing component 362. The head housing 312 may form a semi-circular shape, though other shapes are contemplated. The head housing 312 may have a housing wall 364 that includes a rear wall 366, a top wall 368, and a front wall 370. The rear wall 366 and top wall 368 may be curved and form part of the semi-circular shape of the housing wall 364. The front wall 370 may be flat or slightly curved (e.g., to match the shape of the rear surface of the face 320). A claw-receiving aperture 372 may be defined in the top wall 368. A neck-receiving aperture 374 may be defined in the front wall 370. The neck housing component 362 may have a neck housing component outer surface 376. The neck housing component outer surface 376 may include one or more hammer safety device coupling feature to couple the hammer safety device 300 to the head housing 312. In the depicted embodiment, the hammer safety device coupling feature is a neck housing component recess 378 defined in the neck housing component outer surface 376. As shown, the neck housing component recess 378 is a groove or slot. However, other coupling features are contemplated, including for example, a boss (where the hammer safety device 300 includes a recess), a bayonet connection (e.g., an L-shaped recess or boss), and the like. In some embodiments, the neck housing component 362 is omitted.

The hammer housing 310 may be made of a single component or multiple components. For example, the hammer housing 310 may include a first housing component 380 and a second housing component 382. As shown, the first housing component 380 forms the left side housing and the second housing component 382 forms the right side housing. The first housing component 380 may be coupled to the second housing component 382 to form the hammer housing 310. The hammer housing 310 may include additional components. For example, additional components may be included for aesthetic purposes or for reinforcement.

In several embodiments, the rear wall 366 may have a thickness that is such to withstand pressure exerted on the rear wall 366 when the claw 326 is used to remove a fastener. The housing wall 364 and/or the rear wall 366 may be thicker than the head housing 212 of the hammer 202 depicted in FIGS. 4-13 since the additional metal provided by the head body 216 of the hammer 202 of FIGS. 4-13 that distributes the force created by use of the claw 226 is omitted in the embodiment depicted in FIGS. 14-21. For example, the housing wall 364 and/or the rear wall 366 may have an additional 0.01-0.09 mm thickness, for example 0.05 mm, than the head housing 212 of the hammer 202 of FIGS. 4-13. In some embodiments, the rear wall 366 may include a rear reinforcement wall 384 to remove some of the pressure from the rear wall 366 that is exerted when the claw 326 is in use. The rear reinforcement wall 384 may be positioned inside the housing cavity 360 and may extend into the handle 306. Weakness points may be created on the rear wall 366 due to the combination of metal and plastic in the hammer 302 (for example, the metal claw 326 and plastic housing wall 364), the reduced metal in the head 304, and the curved shape of the housing wall 364. For example, a weakness point may be formed in a position on the hammer housing 310 near where the rear wall 366 meets the handle 306. The reinforcement wall 384 may be positioned behind this weakness point formed between the rear wall 366 and the handle 306. The thicker rear wall 366 and/or reinforcement wall 384 solve the problem created by such weakness points in the disclosed hammer 302. Conventional hammers do not have the same weakness points as the present disclosed hammer 302 and therefore do not have the same housing wall thickness or reinforcement features as the disclosed hammer 302.

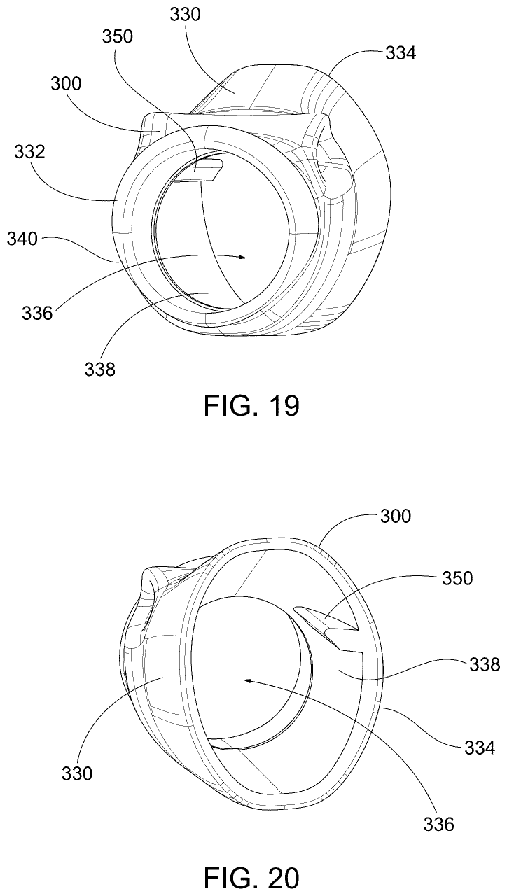

FIG. 19 is a front isometric view of the hammer safety device 300 of the hammer components of FIG. 14. FIG. 20 is a rear isometric view of the hammer safety device 300 of FIG. 19. The hammer safety device 300 may have substantially the same features as the hammer safety device 200 of FIGS. 4-13; however, some features may be omitted for simplicity. For example, as shown, like the hammer safety device 200 of FIGS. 4-13, the hammer safety device 300 includes a safety device body 330 with a first end 332 and a second end 334. The first end 332 of the hammer safety device 300 may define a lip 340. The safety device body 330 and the lip 340 may define a safety device cavity 336. The safety device cavity 336 may be defined by a safety device cavity wall 338. The safety device cavity wall 338 may include one or more housing coupling features to couple the hammer safety device 300 to the hammer housing 310. In the depicted embodiment, the housing coupling feature is a safety device boss 350 that is coupled to the safety device cavity wall 338. However, other coupling features are contemplated, including for example, a recess, groove, slot, or aperture (e.g., where the hammer safety device coupling feature of the hammer housing 310 includes a boss), a bayonet connection (e.g., an L-shaped recess or boss), and the like. In the present embodiment depicted in FIGS. 14-21, the face cavity 242, side face cavity wall 244, and rear face cavity wall 246 of the safety device 200 of FIGS. 4-13 are omitted (e.g., the face cavity 242 and the safety device cavity 236 form a single safety device cavity), thereby reducing the complexity of the hammer safety device 300. In embodiments where the neck housing component 362 is omitted, the safety device 300 may include coupling features designed to couple to the neck 318 instead of neck housing component 362. In such embodiments, the safety device 300 may be coupled to the hammer housing 310 by adhesive.

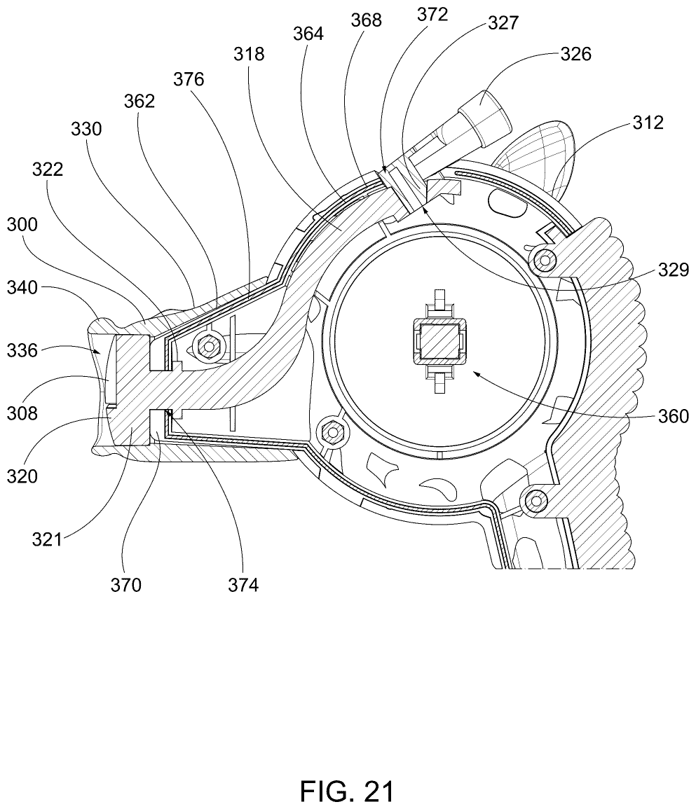

The assembly of the hammer components of FIG. 14 will now be discussed in more detail. FIG. 21 is a cross-section view of the head 304 of the hammer components of FIG. 14 taken along the same line 12-12 of FIG. 4 as FIG. 12. The neck 318 may be positioned through the neck-receiving aperture 374 of the front wall 370 of the head housing 312 such that the rear face surface 309 of the face 320 rests against or is biased against the front wall 370 and the front wall 370 seats in between the face 320 and the neck boss 322. As shown, the front wall 370 fills the gap between the face 320 and the neck boss 322. The neck 318 may be partially surrounded by the neck housing component 362. The neck 318 may be positioned inside the head housing cavity 360 and may curve upwards towards the housing wall 364, specifically, towards the top wall 368. A portion of the neck 318 may be next to or proximate to the housing wall 364. The neck 318 may couple to the housing wall 364. For example, the housing wall 364 may have coupling features on an inner surface of the housing wall 364 that faces the head housing cavity 360. The coupling features of the housing wall 364 may couple the neck 318 to the head housing 312. The neck aperture 329 may align with the claw-receiving aperture 372. The claw boss 327 of the claw 326 may be positioned through the claw-receiving aperture and the neck aperture 329 to couple the claw 326 to the neck 318 and hold the claw 326 in place outside of the head housing cavity 360 and on top of the head 304.

The hammer safety device 300 may be positioned over the neck housing component 362 and may be coupled to neck housing component outer surface 376. For example, the safety device boss 350 may fit inside the neck housing component recess 378. As mentioned above, other coupling features may be included in place of the safety device boss 350 and the neck housing component recess 378. For example, the boss and recess may be inversed (e.g., the boss on the neck housing component outer surface 376 and the recess on the safety device cavity wall 338). As another example, the hammer safety device 300 may be coupled to the head housing 312 by a bayonet connection. It is contemplated that an adhesive (e.g., glue) may be used to secure the hammer safety device 300 to the head housing 312. The tapered shape of the safety device body 330 may align with, correspond to, or match the tapered shape of the neck housing component 362.

The hammer safety device 300 may be positioned such that the safety device body 330 is over the neck housing component 362. In other words, the neck housing component 362 is positioned inside the safety device cavity 336. The portion of the neck 318 that is partially surrounded by the neck housing component 362 may further be partially surrounded by the safety device body 330. The safety device body 330 may extend past the front surface 370 or the safety device body 330 may extend to the front surface 370. In embodiments where the safety device body 330 extends past the front surface 370, the safety device body 330 may fully or partially extend over the face body 321. In such embodiments, the lip 340 may not cover the face body 321 or the lip 340 may extend partially over the face body 321. In embodiments where the safety device body extends to the front surface 370, the lip 340 may extend from the front surface 370 and over the entire face body 321. In any of the foregoing embodiments, the lip 340 may extend over, around, and beyond the striking surface 380. The face 320 may be positioned inside the safety device cavity 336. In this manner, the safety device body 330 may form a sleeve, cover, or guard around the face 320 and the neck housing component 362. Disclosed hammer safety devices (e.g., hammer safety device 100 of FIGS. 1-3, hammer safety device 200 of FIGS. 4-13, and hammer safety device 300 of FIGS. 14-21) may include a material that is softer, more elastic, more flexible, and/or less rigid than a hammer striking surface (e.g., striking surfaces 108, 208, 308) and durable and resilient. The striking surface 108, 208, 308 may be made of a hard or rigid material, such as steel. Disclosed hammer safety devices 100, 200, 300 may be a made of a plastic or rubber material, including, for example, silicone, polyurethane plastic, such as thermoplastic polyurethane (TPU) as an example, and the like. For example, disclosed hammer safety devices 100, 200, 300 may be made of a material that can stretch around head 104, 204, 304 components and/or hammer housing components (e.g., neck housing component 362) and return to a snug or tight fight around the same components.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated and may include wired or wireless connections, including electrical connections. As such, connection references do not necessarily infer that two elements are directly connected and in fixed relation to each other. The exemplary drawings are for purposes of illustration only and the dimensions, positions, order, and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

We claim:

1. A hammer, comprising:
a head comprising a striking surface;
a handle coupled to the head; and
a lip surrounding an outer periphery of the striking surface, wherein the lip is made of a material that is softer and more elastic than the striking surface, and
wherein the lip extends out beyond the striking surface to contact a surface without the striking surface contacting the surface.

2. The hammer of claim 1, wherein the striking surface has a convex shape that forms a peak, wherein the peak minimizes a surface area of the striking surface that contacts a fastener.

3. The hammer of claim 2, wherein the peak is formed at a center of a circle formed by the lip, and wherein the arrangement of the lip and the peak prevents a user from striking the striking surface against the user's fingers when striking the hammer against a fastener.

4. The hammer of claim 1, wherein the striking surface comprises metal and the lip comprises a rubber or silicone material.

5. The hammer of claim 1, wherein the lip is an integral component of a hammer safety device, and wherein:
the hammer safety device further comprises a safety device body,
the safety device body is coupled to the head,
the safety device body has an elongated cylindrical shape,
the safety device body comprises a first safety device body end and a second safety device body end, and
the lip is positioned at the first safety device body end.

6. The hammer of claim 5, wherein the safety device body tapers from the second safety device body end to the first safety device body end.

7. The hammer of claim 5, wherein
the head further comprises:
a neck,
a face coupled to a neck, wherein the striking surface forms a front surface of the face, and wherein the face has a diameter that is greater than a diameter or width of the neck, and
a head housing, the head housing comprising a neck housing component,
wherein at least a portion of the neck is surrounded by the neck housing component, and wherein the safety device body is coupled to the neck housing component.

8. The hammer of claim 7, wherein:
the safety device body comprises a safety device cavity wall that defines a safety device cavity,
the safety device cavity wall comprises one of a safety device boss or a safety device recess,
the neck housing component comprises a neck housing component outer surface,
the neck housing component outer surface comprises one of a neck boss or a neck recess, and
the safety device boss is coupled to the neck recess or the safety device recess is coupled to the neck boss to couple the safety device body to the neck housing component.

9. The hammer of claim 7, wherein the safety device body tapers from the second safety device body end to the first safety device body end forming a tapered shape of the safety device body, and the neck housing component tapers as it extends out from the head housing forming a tapered shape of the neck housing component, and wherein the tapered shape of the safety device body aligns with the tapered shape of the neck housing component.

10. A hammer, comprising:
a head, comprising:
a neck, and
a face coupled to the neck, wherein the face has a diameter that is greater than a diameter or width of the neck and the face defines a striking surface;
a handle coupled to the head; and
a hammer safety device coupled to the head, the hammer safety device comprising:
a safety device body, wherein at least a portion of the neck is surrounded by the safety device body, and
a lip defined at one end of the safety device body, wherein the lip at least partially surrounds a circumference of the striking surface and extends outward from the striking surface, and wherein the lip is made of a material that is more elastic than a material of the striking surface.

11. The hammer of claim 10, wherein the lip and the safety device body define a safety device cavity, and wherein the face is positioned inside the safety device cavity.

12. The hammer of claim 11, further comprising a head housing that at least partially surrounds the neck, wherein
the head housing comprises an outer housing surface,
the outer housing surface defines a recess,
the safety device cavity is defined by a safety device cavity wall,
the safety device cavity wall comprises a boss, and
the boss is positioned in the recess to couple the hammer safety device to the head.

13. The hammer of claim 12, further comprising a claw, the claw comprising a claw boss on a bottom surface of the claw, wherein:
the head housing comprises a claw aperture on a top surface of the head housing,
the neck curves up towards the top surface,
the claw boss is positioned through the claw aperture and is coupled to the neck, and
the head housing comprises a reinforced rear surface that withstands pressure exerted on the rear surface when the claw is in use.

14. The hammer of claim 13, wherein the neck and the claw comprise metal and the head housing comprises plastic.

15. The hammer of claim 10, wherein the hammer safety device is fixedly coupled to the head by adhesive.

16. The hammer of claim 10, wherein the hammer safety device comprises silicone or rubber.

17. A hammer safety device, comprising:
a safety device body; and
a lip defined at a first end of the safety device body, wherein the lip forms a ring around a circumference of the safety device body and wherein the lip has a diameter that is sized to correspond to a size of a diameter of a striking surface of a hammer;
wherein the safety device body and the lip define a safety device cavity, wherein the safety device cavity is sized and shaped to correspond to a size and shape of a neck or a housing of the hammer.

18. The hammer safety device of claim 17, wherein the safety device body has an elongated cylindrical shape that is tapered from a second end of the safety device body to the first end.

19. The hammer safety device of claim 17, wherein the safety device cavity is defined by a safety device cavity wall, and wherein the safety device cavity wall comprises a boss or recess to couple to a corresponding recess or a corresponding boss of the neck or of the housing of the hammer.

20. The hammer safety device of claim 17, wherein the lip comprises a rubber or silicone material.
